(19) United States
(12) Patent Application Publication
(10) Pub. No.: US 2016/0154542 A1
(43) Pub. Date: Jun. 2, 2016

(54) ELECTRONIC DEVICE FOR EVENT ALERT AND NOTIFICATION

(71) Applicants: Hong Shen, Palo Alto, CA (US); Zhuowen Sun, Campbell, CA (US)

(72) Inventors: Hong Shen, Palo Alto, CA (US); Zhuowen Sun, Campbell, CA (US)

(21) Appl. No.: 14/557,297

(22) Filed: Dec. 1, 2014

(51) Int. Cl. G06F 3/0482; G06F 1/16

(52) U.S. Cl. CPC G06F 3/0482; G06F 1/1601

(57) ABSTRACT

The electronic device of this invention is generally for an event alert and notification. The electronic device provides a new concept wherein the electronic device is light weight, wearable, attachable to other accessories such as a backpack, is specifically designed for calendaring, event viewing, graphical notification, and alarm. The general purpose of the present invention is to provide an electronic device for calendaring, alert, and event notification, that has many advantages and novel features over existing technology and devices. To attain this, the electronic device generally comprises an electronic screen, an optional memory storing an event, and a circuit connecting the display and the memory. A frame, made of a flexible material, has a means for attaching such a device to attach the device to typical accessories such as a handbag, a backpack, or a refrigerator.

### TECHNICAL FIELD OF THE INVENTION

The present invention relates generally to an electronic device, and more specifically, relates to an electronic device for event alerting and scheduling.

### BACKGROUND OF THE INVENTION

It can be appreciated that calendars have been used to remind people of a set time, an upcoming appointment, or an event. Typically, an electronic calendar function, such as those maintained by Google, Yahoo, and Apple, let people set up a schedule on an electronic device such as a computer, a mobile phone, a tablet, or a pad. When an event is approaching, a notification can be shown on the electronic device alarm a user of such an event.

One problem with a relevant electronic calendar is that an expensive device such as a mobile phone or a table computer must be used. It is cumbersome for certain people, e.g., young children since young children would not normally carry a mobile phone or a tablet everyday. Although an alarm watch can also achieve the same result of notification, such an alarm watch is only time-based and cannot generate notifications with event descriptions. Another problem is that it is inconvenient to carry a mobile phone or a computer during certain activities, e.g., playing baseball or driving car. Another problem is that mobile phones, portable computers, and tablets often do not have water proof function such that they cannot be used in harsh environments such as in a rain. Yet another problem is that although these above-mentioned devices generate a notification with text, sometimes with a sound alarm or a vibration of the devices or a combination of them, none of them generate a graphic notification that would be attractive to people with certain age, e.g., young children. Yet another problem is that these devices are run on conventional batteries such that if the battery runs out, there is no other way to access the calendar without first charging the devices. Yet another problem is that a mobile phone, a computer, or a tablet, is not to attach to accessories such as a backpack. Moreover, an additional problem is that current electronic devices can only notify by chimes, ringing tones, or vibration, there is no text to voice conversion function such that a person would easily determine what the notification is for.

Thus, there is a need to develop a portable device to display a notification and alarm. Such a device is low cost, weather proof, and is easily attached to accessories such as a backpack or a jersey. Such a device also displays graphical notification instead of a sound or a vibration. In addition, such a device may also announce the notification by human voice.

### SUMMARY OF THE INVENTION

The electronic device as described by this invention solves the problems associated with the above-mentioned relevant devices for calendar viewing and related art.

In view of the foregoing disadvantages inherent in the known types of relevant devices for notification and alert, such as a mobile phone, the present invention provides a new concept wherein the electronic device is light weight, wearable, attachable to other accessories such as a backpack, is specifically designed for calendaring, event viewing, graphical notification, and alarm.

The general purpose of the present invention, which will be described subsequently in a greater detail, is to provide an electronic device for calendaring, alert and notification, that has many advantages over existing technology and devices mentioned heretofore and many novel features that result in a new device which is not anticipated, rendered obvious, suggested, or even implied by any of the prior art devices or technologies, either alone or in any combination thereof.

To attain this, the present invention generally comprises an electronic screen, an optional memory storing an event, and a circuit connecting the display and the memory. A frame, made of a flexible material, has an attachment layer such a device of the present invention on a side opposite to the electronic screen. Such an attachment layer is used to attach the device of the present invention to typical accessories such as a handbag, a backpack, or a refrigerator. Depending on different surfaces the device of present invention is intended to attach, the attachment layer is interchangeable to suit for different surfaces. For example, a Velcro tape may be used to attach the device of present invention to a backpack surface. A magnetic strip may be used for attaching the device of the present invention to a door of a refrigerator. A suction cup may be used for attachment to a mirror surface or a granite countertop surface. A wristband may be used for wearing the device of the present invention around a user's arm. On the frame, opposite to the electronic screen, there is a receiving means to fix the attachment layer onto the frame. Such a receiving means can be a screw, nuts, bolts, sticky tape, glue, Snap-On, or the like.

The device of the present invention displays a notification in a graphical pattern. For example, a cartoon of soccer ball for a soccer practice. An end user would know the detail of the notification after a simple glimpse of the screen. This is useful during driving or to users of certain ages, such as a small child. It is also useful in certain events, for example, reminding a patient to take certain medicines at certain times. The displayed graphical notification may flash during an alarm to distinguish other events that are also displayed in graphics but not yet due. In addition, the flashed graphics may also change color or pattern to alarm the user of a notification.

The device of the present invention has a text to voice function such that a notification may be announced by a human voice. This is useful during driving when a user cannot attend to the screen of the device to ascertain the details of the notification.

The device of the present invention may be made of flexible material and powered by solar power or other suitable power sources. It may also be powered by human kinetics.

There have thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description and of being practiced and carried out in various ways. Also, it is to be understood that the phraseology and terminology employed herein are for the purpose of the description and should not be regarded as limiting.

Therefore a primary object of the present invention is to provide an electronic device that overcomes the shortcomings of the devices in relevant arts.

An object of the present invention is to provide an electronic device that displays a calendar and allows a user to set up a schedule.

Another object of the present invention is to provide an electronic device that displays a notification in graphics.

Another object of the present invention is to provide an electronic device that announces a notification and alert in a human voice.

Another object of the present invention is to provide a flexible electronic device that is water proof.

Another object of the present invention is to provide an electronic device that is attachable to other accessories such as a backpack.

Another object of the present invention is to provide an electronic device that is light weight and low cost.

Other objects and advantages of the present invention will become obvious to the reader and it is intended that these objects and advantages are within the scope of the present invention.

To the accomplishment of the above and related objects, the present invention may be embodied in the form illustrated in the accompanying drawings. Various objects, features, and attendant advantages of the present invention will become fully appreciated as the same becomes better understood when considered in conjunction with the accompanying drawings. Attention being called to the fact, however, that the drawings are illustrative only, and that changes may be made in the specific construction illustrated.

### BRIEF DESCRIPTION OF DRAWINGS

FIG. 1 is a perspective front view of the electronic device.

FIG. 2 is a perspective right side view of the electronic device.

FIG. 3 is a perspective left side view of the electronic device.

FIG. 4 is another left side view in a separate embodiment of the electronic device.

FIG. 5 is a perspective backside view of the electronic device.

FIG. 6 is a showing of a notification by flashing on the screen of the device.

FIG. 7 is a showing of a notification by graphics on the screen of the device.

FIG. 8 is a showing of an alarm by flashing the graphics on the screen of the device.

FIG. 9 is a showing of the device attached to a backpack.

FIG. 10 is a showing of the device attached to a door of a refrigerator.

### DETAILED DESCRIPTION OF THE INVENTION

The present invention relates to an electronic device for notification and event alert.

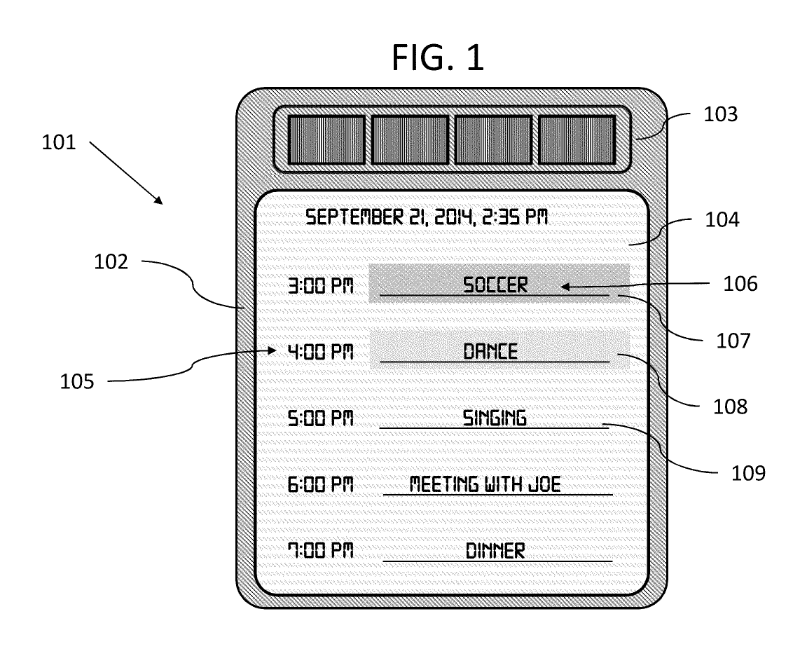

Turning now descriptively to the drawings, in which similar reference characters denote similar elements throughout the several views. The attached FIG. 1 is a perspective front view of the electronic device 101 of the present invention. The device 101 comprises a frame 102. Such a frame 102 may be made of metal, for example, aluminum. It may also be made of plastics such as polyethylene, polyvinyl chloride, polystyrene, polycarbonate, or other similar materials. Silicone rubber may alternatively be used to make the frame 102. Embedded in the frame is a power source 103, which is shown as a solar cell battery. Those skilled in the art would understand that FIG. 1 is for illustration purpose only and the actual configuration of the power source 103 and its location relative to the frame 102 may be different than the one drawn in FIG. 1. Embedded in the frame 102 there is an electronic screen 104, which displays generally a date and a time. An event list 105 is displayed on the electronic screen 104. For example, the electronic screen 104 may be split in two columns, with one column displaying time only and the other one displays textual event information at specified time. As shown in FIG. 1 for example, the set time on the left side of the electronic screen is between 3 to 7 pm, with one hour interval. On the right side there is a text 106 displayed, such as “SOCCER” for soccer practice at 3 pm, “DANCE” for a dancing class at 4 pm, “SINGING” for a singing class at 5 pm, “MEETING WITH JOE” for a meeting at 6 pm, and “DINNER” for a dinner party at 7 pm. Unlike other devices that display events for an entire day, the device 101 in the present invention only displays a calendar that within a few hours starting from the current time. For example, FIG. 1 shows 2:35 pm as the current time and the calendar displays only events that start from 3 pm, which is next time slot that an alarm is set, to 7 pm, which is only 4 hours from the current time. As time goes on, the calendar displays the next closest hour when an alarm is set. Alternatively, the event list 105 may display one closest event and its set time only. To show the closeness of an event relative to the current time, the event list 105 may display an event in different shades. For example, in FIG. 1, the current time is 2:35 pm. The next event approaching is the soccer practice at 3:00 pm, which is displayed in a greatest shade 107. The shade may be in the background enclosing the “SOCCER” text or the text 106 itself. The next event, dancing class at 4:00 pm, is the next event coming up but relatively far away temporally, such that this event “DANCE” is displayed in a lighter shade 108. The subsequent events, the 5:00 pm singing class, the 6:00 pm meeting with Joe, the 7:00 pm dinner party, are too far away temporally such that they are displayed with normal background 109 with no shade. Preferably, shade 107, 108, and 109 may be in different colors, with 107 in a warm color such as red to indicate the closest event, 108 in a cooler color such as yellow to indicate the next approaching event, and 109 in a cold color such as blue or green or no color to indicate events far away. Similarly, the color may be in the text 106 itself or the background surrounding the text 106. In one embodiment, the device 101 may be powered by human kinetics power such that the power source 103 may not be needed.

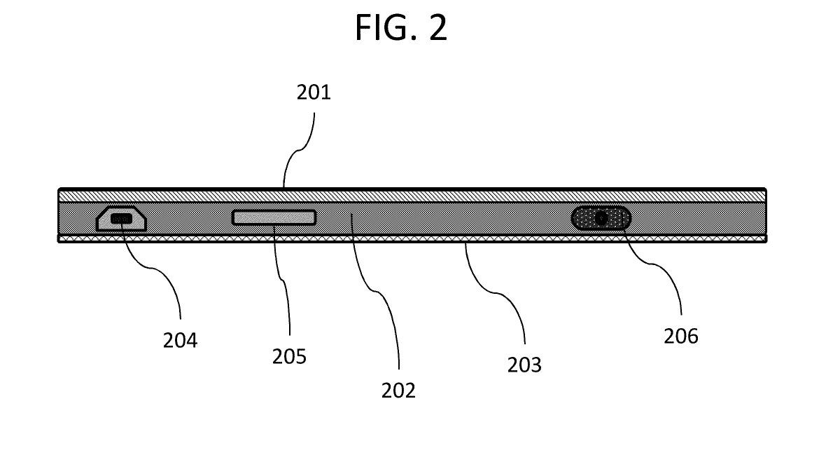

Referring to FIG. 2 now. Viewed from a side, the electronic device 101 may have top surface cover 201 on the frame 102 to protect the power source 103 and the electronic screen 104. The top surface cover 201 may be made of water resistant material such as silicone rubber or polyurethane such that the electronic device 101 is water-proof. The frame 102 has a sidewall 202 which may be as thin as a few millimeters. 203 is a side view of an attachment layer of the electronic device 101 to a surface of an accessory. The means 203 may be made of sticking tapes to attach the electronic device 101 to a surface on a backpack, a bag, a purse, for example. The means 203 may also be made of a Velcro tape, where the attached surface has a corresponding tape to receive the Velcro tape. To attach the electronic device 101 to a refrigerator surface, the means 203 may be made with magnetic strips. Depending on the surface to be attached, the means 203 may be tailored specifically to that surface. The means 203 may be permanently bonded to the backside of the electronic device 101. Preferably, the means 203 may be made interchangeably so that different material may be used interchangeably and the electronic device 101 may be attached to many accessory surfaces by changing the means 203.

From this side view of the electronic device 101, it may be appreciated that there are buttons on the sidewall 202 of the frame 102. These may include a mini-universal serial bus (“USB”) port 204 for connecting the electronic device 101 to a computer or another portable device; a mini-SD card port 205 to support an external memory device; and a power button 206. These buttons are not necessarily on the electronic device 101. For example, in the embodiment that the electronic device 101 is water-proof, there may be no buttons on the sidewall 202 in order to fully seal the electronic device 101. In another embodiment, there may be no power button 206 such that the electronic device 101 may be turned on by exposing the power source 103, e.g., solar cells to visible lights. Yet in another embodiment, the electronic device 101 may be communicated with a computer or another portable device by wireless, Bluetooth, infrared, or other wireless ways. In such a case, a mini-USB port 204 is not necessary.

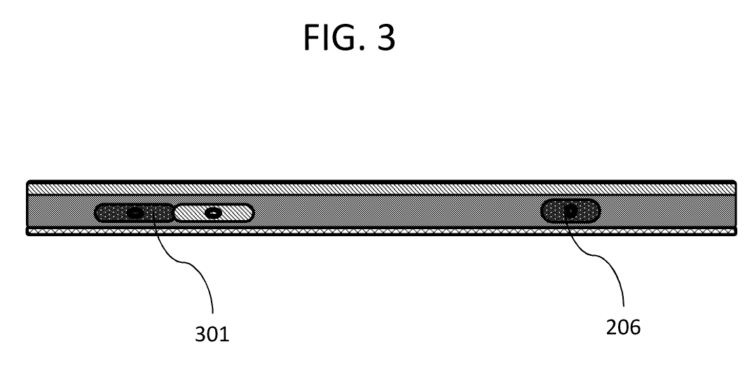

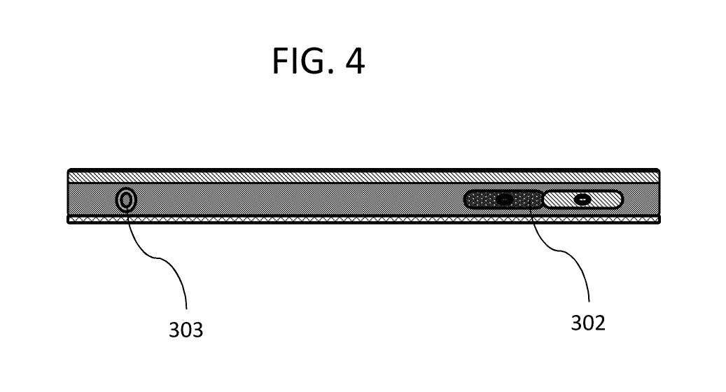

Referring to FIG. 3 and FIG. 4 now. FIG. 3 and FIG. 4 are different examples of different configurations of the side buttons in various embodiments of the electronic device 101. FIG. 3 shows a configuration that a power button 206 on the sidewall towards one end of the electronic device 101. On the same sidewall towards the other end of the electronic device 101 there is a set of buttons 301, with one up button and one down button, which may be used to increase or decrease the volume of the alarm. The same set of buttons 301 may also be used to increase or decrease the brightness of the screen. FIG. 4 shows another sidewall of the electronic device 101, wherein 303 may be an audio jack or a serial port for connection and 302 may be another set of buttons for volume or brightness adjustment. Similar buttons may also include buttons for silence the alarm, reset, sleep, for example.

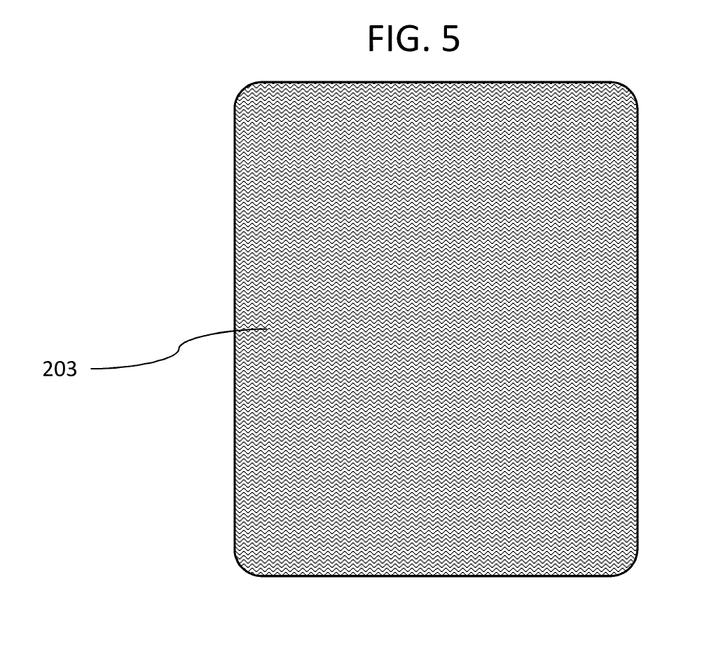

Referring to FIG. 5 now. FIG. 5 is a view of a backside of the electronic device 101. The attachment layer 203 may be a full sheet of material bonded on the backside of the electronic device 101. The full sheet of material may be Velcro, sticky tape, magnetic material, for example. The means 203 may also be in any patterns such as a cross, an “X”, concentric circles, rows, columns, dots, or any combinations of such as patterns. The means 203 may temporarily installed on the backside of the electronic device 101. For example, a self-adhesive may be used to install the attaching means 203. Alternatively, the means 203 may also be permanently bonded to the frame 102 of the electronic device 101.

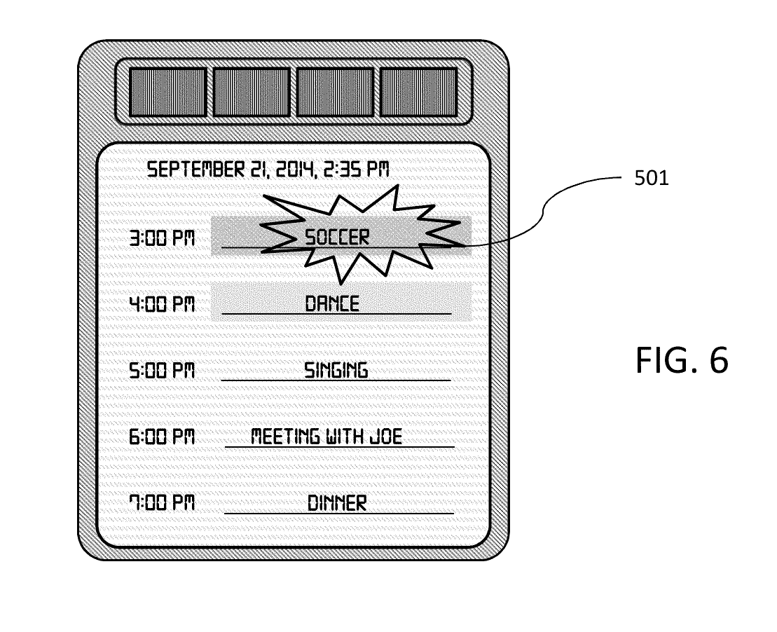

Referring to FIG. 6 now. FIG. 6 shows the event list 105, wherein the first event 501 “SOCCER” is set at 3:00 pm and the electronic device 101 alerts at the set time. Instead of alerting in a sound, the electronic devices 101 alerts by flashing. The flashing may be made by flashing the text “SOCCER” associated with the event or alternatively, the background under and surrounding the text “SOCCER” may also be flashed to notify the end user. Alternatively, the entire screen 104 may be flashing at the set time. During the flash, the text “SOCCER” may change color. If the background is flashing, the background may change color.

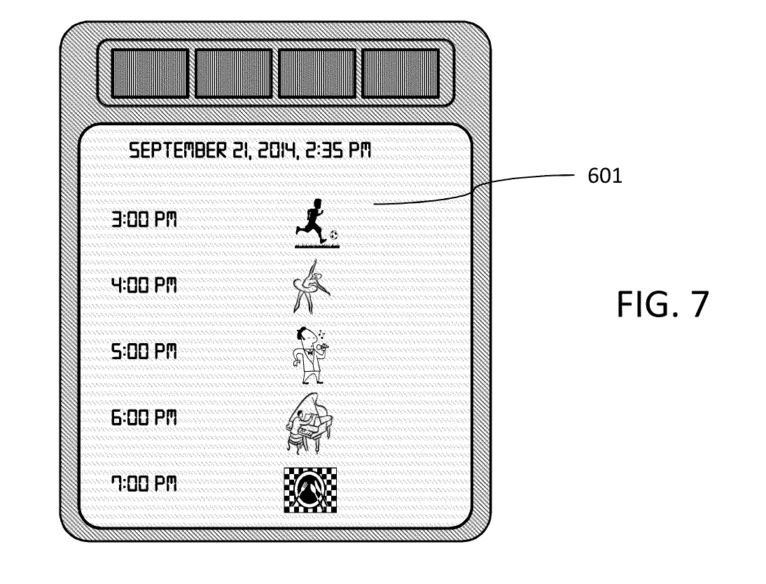

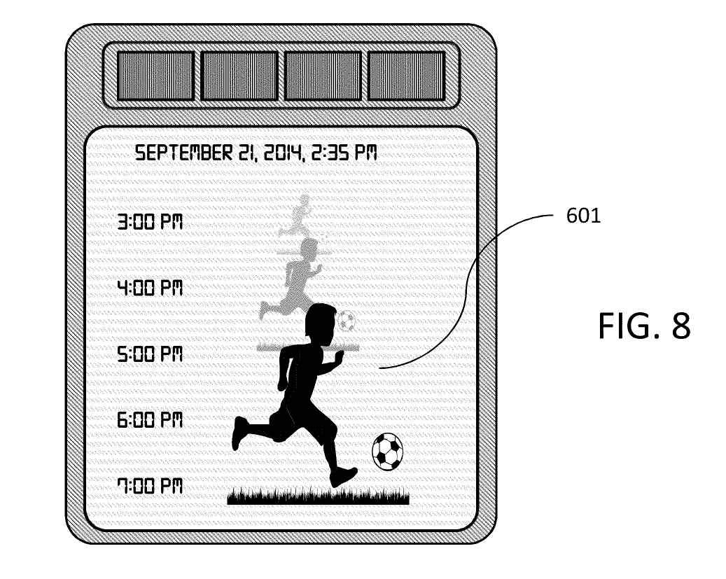

Referring to FIGS. 7 and 8 now. Instead of showing texts in the event list 105, the electronic device 101 may preferably display icons or cartoons 601 for set alert. In FIG. 7, the text “SOCCER” is replaced by a cartoon in which a small boy is kicking a soccer ball. This is attractive to people with certain ages such as small children. Similarly, the text “DANCE” is replaced by a cartoon that shows a girl dances ballet. The text “SINGING” is replaced by a cartoon that shows a person holding a microphone, with apparent gesture of singing. The text “PIANO” is replaced by a cartoon in which a person is playing a piano. The text “DINNER” is replaced by a cartoon that shows a dinner mat with a set plate and utensils, apparently ready for dinner. The cartoons shown in FIG. 7 are only examples and in the actual electronic device 101, a user is able to design and use a cartoon that the user prefers. FIG. 8 shows the alarm mode when the electronic device 101 alarms for the 3:00 pm soccer practice. The soccer cartoon 601 flashes by increasing its size and eventually occupies the full screen, while other events/time in the calendar 105 appear grayish or fadeout such that the user may focus on the alarm, not to be distracted by the other events on the calendar 105. The cartoons 601 may be pre-stored in the device 101. Preferably, the cartoons 601 may also be user-generated from another device and transferred into the device 101.

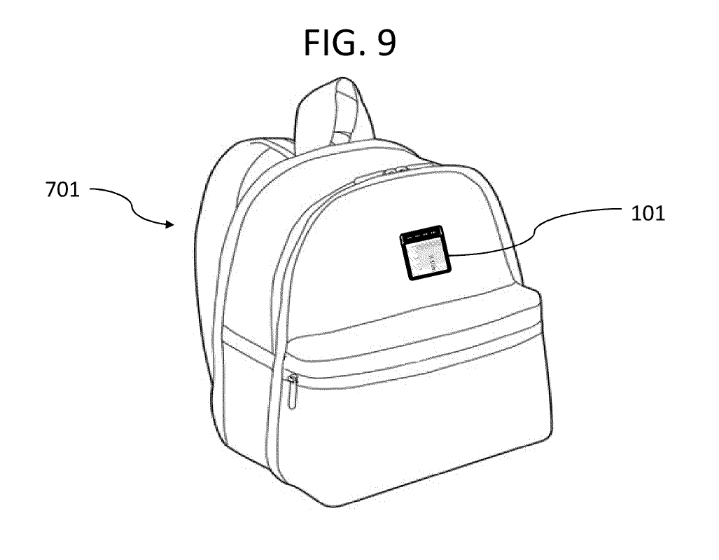

Referring to FIG. 9 now. FIG. 9 shows an example attachment of the electronic device 101 on an accessory. This example shows a backpack 701, which is commonplace for school age children. An electronic device 101 is attached to the front surface of the backpack 701 by possible attaching means that are suitable for fabrics, leather, cotton, for example.

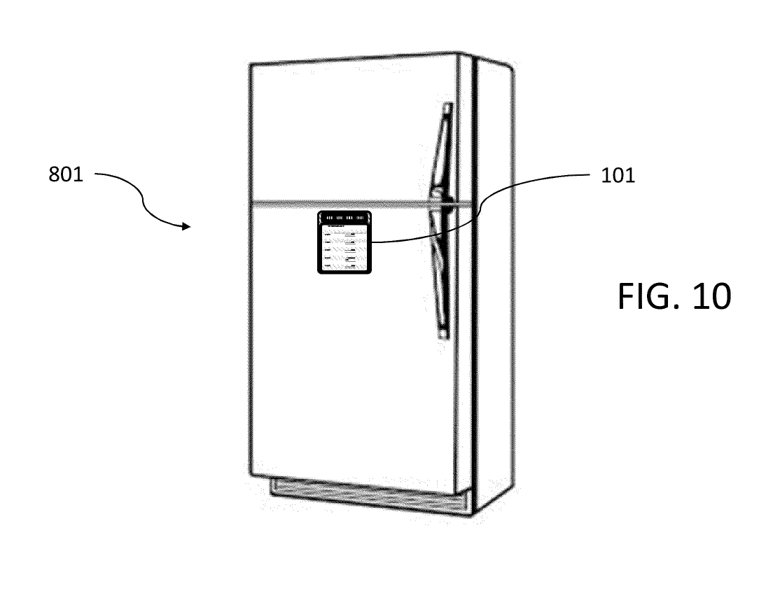

Referring to FIG. 10 now. FIG. 10 is another example attachment of the electronic device 101 on an appliance. In this example, a refrigerator 801 is shown and an electronic device 101 is attached to the front door of the refrigerator 801, which may be made of stainless steel, plastics, rubber, for example.

The method of using the electronic device 101 is as follows. An end user connects the electronic device 101 with a computer, a mobile phone, or another similar device. The event list 105 may be edited and alerts may be set on the computer, for example. Preferably, the electronic device 101 may have a touch screen such that a calendar may be directly edited without using other devices. The connection with other devices may be by wireless, Bluetooth, wired, infrared, or other suitable means to sync and update the calendar 105 on the electronic device 101. In the preferred embodiment where graphics (cartoons) are shown on the screen 104, a user may choose a cartoon from a library, for example, a pre-installed graphics library in the device 101. A user may also design and edit his or her own cartoon at another device and transfer the graphics to the device 101 by wired or wireless communication. A computer may be useful instead of editing directly on the electronic device 101 for a reason that using a computer to design and draw such a cartoon may be easier than doing it on the small screen of the electronic device 101.

Once the events and the alerts are set. The user attaches the electronic device 101 onto an accessory, for example, a school backpack. To attach the same electronic device 101 to another surface, for example, a refrigerator surface, the attachment layer 203 on the backside of the electronic device 101 is uninstalled from the device, another attachment layer such as a magnetic strip may be installed for that purposes, where both the attachment layer 203 and the magnetic strip may have a self-adhesive layer to be installed on the backside of the electronic device 101.

As to a further discussion of the manner of usage and operation of the present invention, the same should be apparent from the above description. Accordingly, no further discussion relating to the manner of usage and operation will be provided.

With respect to the above description thereof, it is to be realized that the optimum dimensional relationships for the components and assembly parts of the present invention, to include variations in size, materials, shape, form, function, and manner of operation, assembly, and use, storage and transportation, are deemed readily apparent and obvious to one skilled in the art, and all equivalent relationships to those illustrated in the drawings and described in the foregoing specification are intended to be encompassed by the present invention.

Therefore, the foregoing is considered as illustrative only on the principles of the present invention. Further, since numerous modifications and changes, as the device of the present invention being developed, will readily occur to those skilled in the art, it is not desired to limit the present invention to the exact construction and operation shown and described, and accordingly, all suitable modifications and equivalents may be resorted to, falling within the scope of the present invention.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. An electronic device, comprising:
a frame having a first side and a second side;
an electronic screen, installed on said first side of said frame, wherein said electronic screen displays a notification in a graphic manner;
a power supply to provide electricity to said electronic device;
a user interface for a user to input a schedule and set up an alert;
an integrated circuit, wherein said integrated circuit is electronically connected to said power supply, said user interface, and said electronic screen; and
an attachment layer to attach said electronic device to a surface, wherein said attachment layer is interchangeably installed on said second side of said frame.

2. The electronic device of claim 1, further comprising displaying an upcoming event where an alarm is set.

3. The electronic device of claim 2, wherein said electronic device is flexible.

4. The electronic device of claim 2, wherein said electronic device is water-proof.

5. The electronic device of claim 2, wherein said attachment layer is a Velcro tape.

6. The electronic device of claim 2, wherein said attachment layer is a magnetic strip.

7. The electronic device in claim 2, wherein said user interface is a touch screen.

8. The electronic device of claim 2, wherein said power supply is a solar cell panel.

9. A flexible electronic device, comprising:
a frame having a first side and a second side;
an electronic screen, installed on said first side of said frame, wherein said electronic screen displays a notification in a graphic manner;
an alarm, wherein said alarm is connected to said integrated circuit;
a power supply to provide electricity to said electronic device;
a user interface for a user to input a schedule and set up an alarm;
an integrated circuit, wherein said integrated circuit is electronically connected to said alarm, said power supply, said user interface, and said electronic screen; and
an attachment layer to attach said electronic device to a surface, wherein said attachment layer is interchangeably installed on said second side of said frame.

10. The electronic device of claim 9, further comprising a receptacle to fix said attachment layer on said frame.

11. The electronic device of claim 10, wherein said electronic device is water-proof.

12. The electronic device of claim 10, wherein said attachment layer is a Velcro tape.

13. The electronic device in claim 10, wherein said user interface is a touch screen.

14. The electronic device of claim 10, wherein said power supply is a solar cell panel.

15. A method for using an electronic device for notification and event alert as in claim 1, said method comprising:
providing an electronic device for notification;
synchronizing said electronic device with other devices for notification;
displaying a notification in a graphic pattern on said electronic device;
notifying a user of an event on or before a set time; and
alerting a user of an event at said set time.

16. The method of claim 10, further comprising permitting a user to acknowledge a notification.

17. The method of claim 16, further comprising displaying a notification with different shades.

18. The method of claim 16, further comprising displaying a notification with different colors.

19. The method of claim 16, further comprising displaying a notification with different font sizes.

20. The method of claim 16, further comprising displaying a notification in a changing pattern at said set time.
